(19) United States
(12) Patent Application Publication
(10) Pub. No.: US 2007/0107891 A1
(43) Pub. Date: May 17, 2007

(54) Utility vehicle cooling system

(76) Inventor: James B. Tieken, Henderson, NV (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/280,996

(22) Filed: Nov. 17, 2005

(51) Int. Cl. B60H 1/00

(52) U.S. Cl. 165/202

(57) ABSTRACT

A system for cooling an occupant of a vehicle comprises a mechanical refrigeration unit carried by the vehicle. The refrigeration unit is capable of generating a mechanically cooled fluid. The system includes at least one fan for directing the mechanically cooled fluid to a designated area. A control switch may be provided for activating the fan independent of the refrigeration unit.

### BACKGROUND

1. Technical Field

The present application relates to a cooling system for a vehicle, and more particularly, to a portable personal cooling system or unit for use in a vehicle, such as an electrically-powered utility vehicle.

2. Background Information

In recent years there has been a vast increase in the development and use of vehicles that are designed for a specialized use. Such vehicles include, among others, golf carts, landscaping maintenance vehicles, factory transportation vehicles, personal mobility vehicles, and the like. In many cases, these vehicles are powered, in whole or in part, by chargeable electrical batteries.

Utility vehicles of this type are often used in ambient environments that are subject to temperature extremes. Generally, such extremes relate to elevated temperatures. Whether such use is on the golf course, or in a factory or warehouse, these temperature extremes can be uncomfortable for the operator of the vehicle, as well as for passengers who are riding in the vehicle. Attempts have been made in the past to provide mechanisms for cooling the occupants of such vehicles. Such mechanisms have included misting systems, evaporative cooling systems, and ice cooled blower systems. Although some temporary relief may be provided by such systems, the amount of cooling provided is generally ineffective to provide meaningful cooling for the occupants of the vehicle. In addition, such systems generally lack the capacity to maintain a reasonable level of cooling for anything other than a brief period of time.

It would be desirable to provide a temperature control system or unit for a utility vehicle of the general type described above that overcomes the problems of the prior art. More particularly, it would be desirable to provide a temperature control system or unit that is capable of providing meaningful relief to the occupants of the vehicle, and that is capable of sustaining that relief for an extended period of time. Furthermore, it would be desirable to provide such a system or unit that is capable of providing effective sustained cooling and does not adversely affect the power requirements of the vehicle in a significant manner.

### BRIEF SUMMARY

The problems of the prior art are addressed by the present invention. In one form thereof, the invention comprises a system for cooling an occupant of a vehicle. The system comprises a refrigeration unit carried by the vehicle, which refrigeration unit is capable of generating a mechanically cooled fluid. At least one fan is provided for directing the mechanically cooled fluid to a designated area. An optional control switch may be provided for activating the fan independent of the operation of the refrigeration unit.

In another form thereof, the invention comprises a vehicle and a refrigeration unit carried by the vehicle. The refrigeration unit is capable of generating a mechanically cooled fluid for cooling a designated area. At least one fan is provided for directing the mechanically cooled fluid to the designated area. A battery power system is provided for facilitating movement of the vehicle.

In still another form, the invention comprises a cooling system for a utility vehicle. The cooling system comprises a refrigeration unit carried by the vehicle. The refrigeration unit comprises a condenser, a compressor and an evaporator, and is capable of generating a mechanically cooled fluid. The refrigeration unit includes a plurality of evaporator fans for directing the mechanically cooled fluid to respective designated areas. A plurality of control switches are provided to each activate a separate fan independent of the operation of the refrigeration unit.

### BRIEF DESCRIPTION OF THE DRAWINGS

FIG. 1 is a perspective view of a utility vehicle equipped with a cooling system according to an embodiment of the present invention;

FIG. 2 is a side view of the utility vehicle of FIG. 1;

FIG. 3 is a side view of a cooling system of a type that may be used in the present invention;

FIG. 4 is a perspective view of the cooling system of FIG. 3, taken substantially from a position to the rear of the orientation shown in FIG. 3; and

FIG. 5 is one example of a wiring diagram for the inventive cooling system.

### DETAILED DESCRIPTION OF THE DRAWINGS AND THE PRESENTLY PREFERRED EMBODIMENTS

For the purposes of promoting an understanding of the principles of the invention, reference will now be made to the embodiments illustrated in the drawings, and specific language will be used to describe the same. It should nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

The present application describes a personal portable cooling system or unit for use with a vehicle. As used herein, the term “vehicle” is used in a broad sense to include any mechanized device that may be utilized to carry or otherwise transport persons and/or objects from one place to another. Non-limiting examples of vehicles to which the invention is particularly applicable include utility-type vehicles, such as golf carts, landscaping maintenance vehicles, factory and warehouse transportation vehicles, personal mobility vehicles, and the like. Often, but not exclusively, the vehicles will be electrically powered, in full or in part, such as via electrical chargeable storage batteries. Hybrid electrical and gas-powered vehicles are also included.

The inventive portable cooling system incorporates a mechanical refrigeration unit that is sized to provide an effective amount of cooling to cool one or more occupants of the vehicle, and to maintain the cooling capacity for an extended period of time. The inventive cooling system does not appreciably deplete the power supply of the vehicle, has sufficient capacity to effectively cool the occupants of the vehicle, and prevents the system from overheating and shut-off at the time of greatest demand.

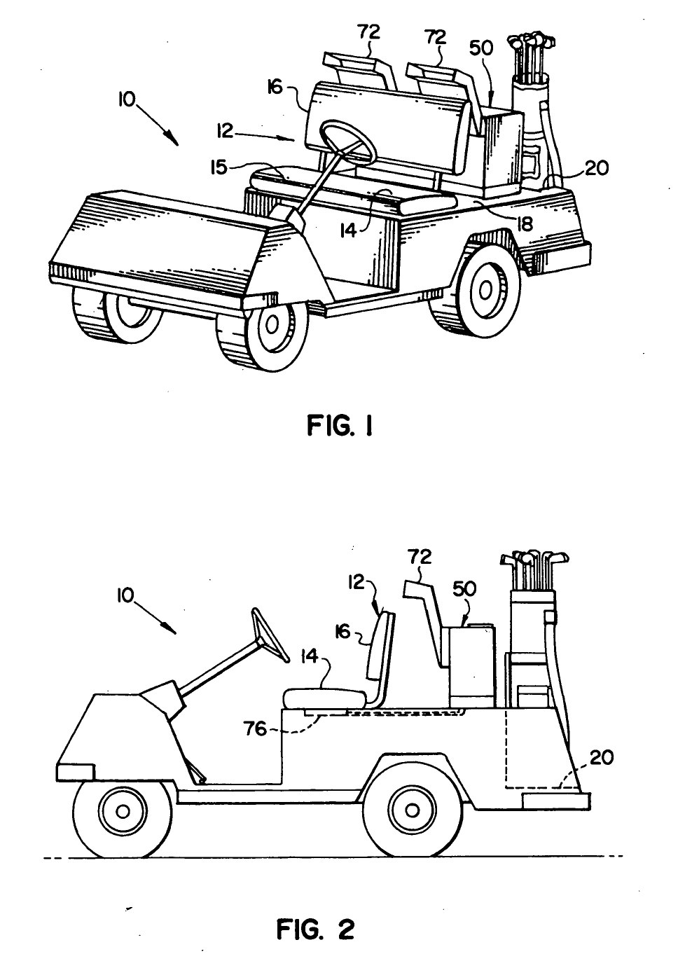

The inventive system is further described by referring to the figures. FIG. 1 is a perspective view of one embodiment of a utility vehicle 10 that is equipped with the inventive cooling system. FIG. 2 is a side view of the utility vehicle of FIG. 1. Although the vehicle shown in FIGS. 1 and 2 is a golf cart, this is merely one possible example of the type of vehicle with which the inventive cooling system may be utilized, and is not intended to limit the types of vehicles that may be cooled by the inventive cooling system.

The vehicle shown in FIGS. 1 and 2 includes a conventional seat portion 12. Seat portion 12 will generally include a weight-bearing portion 14 and a back rest portion 16. Weight-bearing portion 14 generally comprises a conventional bench that extends substantially the width of the vehicle. Alternatively, weight-bearing portion 14 may comprise two or more discrete individual seats arranged in a manner such that each occupant of the vehicle has his/her own seat. As another alternative, vehicle 10 may include two or more rows of seats, which will be generally, but not exclusively, aligned in parallel fashion to increase the seating capacity of the vehicle.

Vehicle 10 also may include one or more support surfaces, as shown in FIGS. 1 and 2. When present, support surface 18 may be utilized for supporting a cooling system 50. A separate support surface 20 may optionally be provided for carrying miscellaneous items for utilization by the driver of the vehicle, such as the set of golf clubs shown in the figures. Surfaces 18, 20 need not be positioned exactly as shown in the figure, and the vehicle 10 need not necessarily even include discrete support surfaces for these items as shown. The support surfaces are shown in the drawings for the sole purpose of illustrating one possible placement of cooling system 50 and any other miscellaneous items in the utility vehicle. Those skilled in the art will appreciate that cooling system 50 may be placed at a multitude of possible positions in the utility vehicle, with the support surface 18 shown being just one preferred arrangement. Those skilled in the art will also appreciate that the utility vehicle with which the cooling system is employed may have more, or fewer, discrete support surfaces than shown in the example of FIGS. 1 and 2, dependent primarily upon the nature and intended function of the vehicle.

Existing utility vehicles sometimes incorporate systems that are intended to provide cooling air for the benefit of one or more passengers of the vehicle. Such systems normally comprise misting systems, evaporative cooling systems, and ice cooled blower systems. Although capable of providing some temporary relief, these systems are generally ineffective for providing meaningful cooling for the benefit of the occupants of the vehicle. Unlike such prior art systems, the inventive system utilizes a mechanical refrigeration unit that is capable of providing sufficient cooling air for the benefit of the occupants of the vehicle, and of providing such cooling air for an extended period of time.

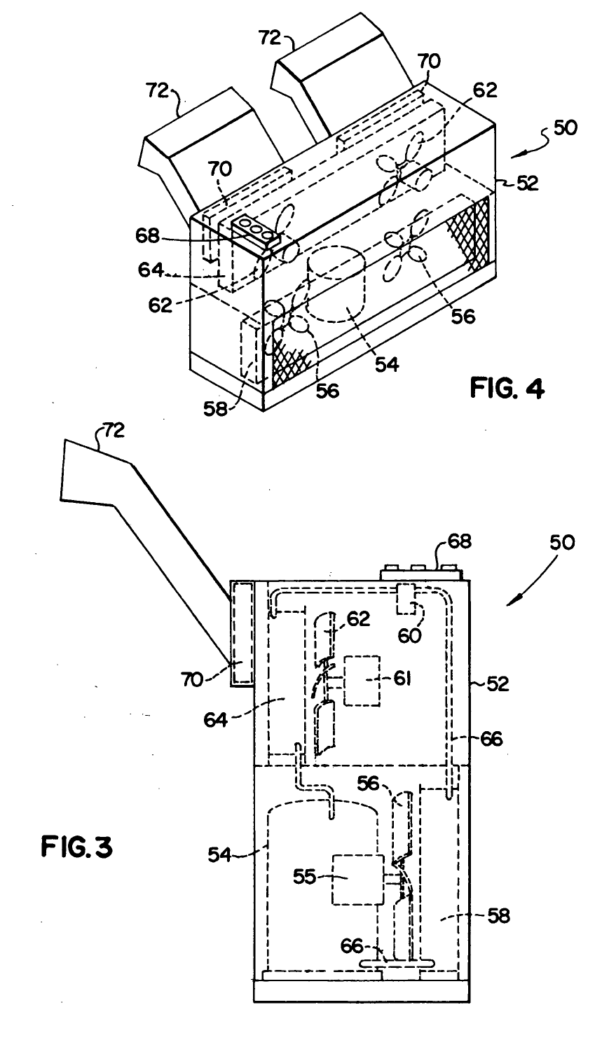

FIG. 3 shows a side view of a cooling system 50 of a type that may be used in the present invention. FIG. 4 illustrates a perspective view of cooling system 50, taken substantially from a position to the rear of the orientation of FIG. 3. The main components that make up the refrigeration system are generally shown in phantom in these figures. Cooling system 50 comprises a refrigeration unit including a housing 52 that houses or otherwise supports the conventional components of the refrigeration system, namely the compressor 54, condenser fan motor 55 and condenser fan 56, condenser coil 58, refrigerant metering device 60, evaporator fan motor 61 and evaporator fan 62, and evaporator coil 64. The refrigerant lines are indicated as 66. One or more conventional electrical switches 68 may be provided at a convenient location on housing 52. The components of cooling system 50, some of which are shown in schematic, are generally well-known features of a refrigeration system. Further detailed description of the individual refrigeration components is not required for a thorough understanding of the present invention. Those skilled in the art will appreciate that the conventional refrigeration components may be aligned in the housing in a myriad of permissible ways to obtain the benefit of cooling air, the embodiment described and illustrated herein merely representing one preferred arrangement.

If desired, an optional heater 70 may also be provided for providing heated air to the vehicle occupant(s). The presence of the optional heater 70 increases the versatility of the device, and enables its beneficial use in a wider variety of ambient conditions than may be obtained with only a cooling system.

One or more conduits 72 are provided for directing the treated (i.e., cooled or heated) air onto the occupant(s). Conduits 72 may be discrete units as best shown in FIGS. 1 and 4 for directing treated air toward an intended destination, or alternatively, may be a single unit. The single unit may be provided with separate plenums, fins, or like features that direct a portion of the treated air from a single conduit to an intended destination. Those skilled in the art will appreciate that conduits 72 are merely one possible way in which the treated air may be transmitted for the benefit of the occupants of the vehicle, and any other conventional manner of directing the treated air from the cooling system to its intended destination may be substituted.

In a preferred embodiment of the inventive system, the system is activated for use by one or more pressure switches 76 located under the weight-bearing portion 14 of each of the passenger seats 12. Preferably, a separate switch 76 is located directly under each designated passenger seat portion of a weight-bearing bench, and under each individual seat when discrete seats are provided. Switch 76 is activatable by the weight of an occupant of that seat. Thus, when the driver sits on weight-bearing seat portion 14, a pressure switch 76 positioned directly beneath the driver seat activates a separate one of the evaporator fans. This fan is oriented to blow cooling air through the conduit 72 that is aimed toward the driver seat. Similarly, when a passenger sits on passenger weight-bearing seat portion 14 adjacent the driver seat, a pressure switch 76 beneath the passenger seat activates the other evaporator fan. This fan is oriented to blow cooling air through the conduit 72 that is aimed toward the passenger seat. The system can be structured to include as many separate switches as there are weight-bearing benches or discrete seat areas in the vehicle. In this manner, each individual seat portion preferably corresponds with a separate pressure switch. Of course, if there are more than two seats and pressure switches, the system could be constructed to include additional evaporator fans and conduits to accommodate the direction of cooling air to each designated passenger area.

Although the inventive system need not include a separate switch for each passenger seat area, and could, for example, include a single switch for each bench, it is preferred to have a separate switch to correspond to each designated passenger seating area. This improves the efficiency of the system by eliminating the cooling of areas of the vehicle not occupied by a passenger. Additionally, although it is preferred to utilize pressure switches for activating the respective evaporator fans, those skilled in the art will appreciate that other known activating mechanisms may be substituted.

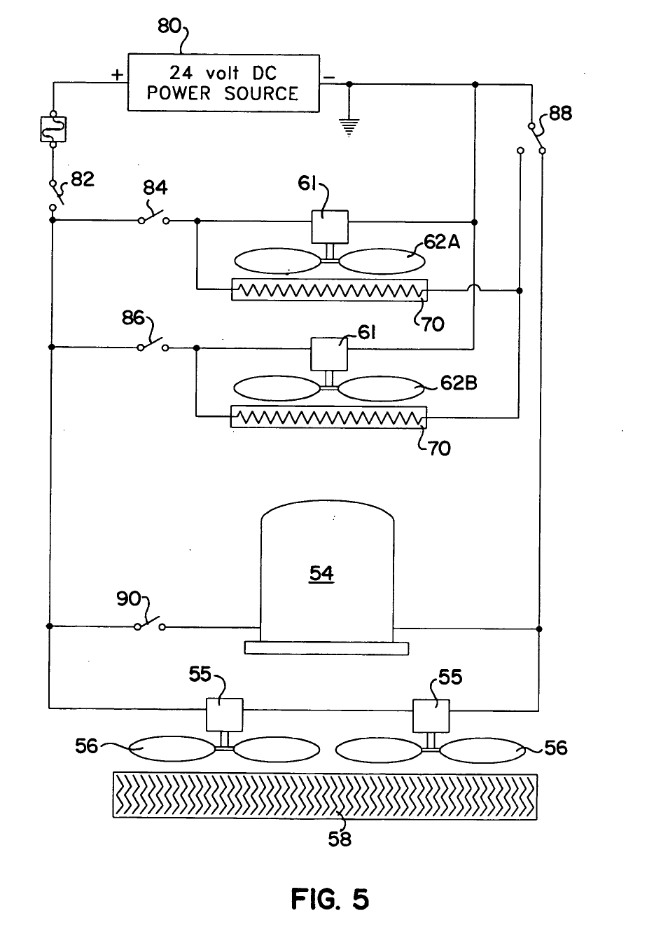

FIG. 5 illustrates one example of a wiring diagram for the inventive cooling system. The wiring diagram of FIG. 5 corresponds to the vehicle of FIGS. 1 and 2, and illustrates one possible way of activating the cooling system. Many of the features of cooling system 50 referenced in FIG. 5 are well known, and are therefore only illustrated schematically in the wiring diagram. The unit may be powered by conventional power sources for such vehicles, such as the 24 volt DC power source 80 illustrated in the wiring diagram. Preferably, an on/off switch 82 is provided to enable the user to selectively activate, or deactivate, the entire cooling system 50. Generally, on/off switch 82 will be located at a convenient location in the vehicle such that it is within easy reach of the driver when seated in the vehicle. Obviously, at times the vehicle will be used in ambient conditions when no cooling/heating is desired. In such instances, switch 82 is simply left in the “Off” position, and the cooling/heating system is not activated. When it is desired to take advantage of the features of the cooling system, the unit may be conveniently activated by turning switch 82 to the “On” position. This may be done before, or after, the driver and/or passenger sit on a seat in the vehicle. When the unit is activated, the compressor, condenser and evaporator are energized in well-known fashion to generate cooling air.

Upon the driver sitting on seat weight-bearing portion 14, driver seat switch 84 is closed. The evaporator fan 62A that corresponds with the driver side conduit is activated, thereby directing cooling air through the designated conduit onto the driver. Similarly, upon a passenger sitting on the passenger seat weight-bearing portion 15, passenger seat switch 86 is closed. The evaporator fan 62B that corresponds with the driver side conduit is activated, thereby directing cooling air through the other conduit onto the passenger.

In a preferred embodiment, a heat/cool switch 88 is provided to selectively manipulate the system between a cooling mode and a heating mode. In this way, one or both of driver side or passenger side heaters 70 may be activated by the respective pressure switch relating to the driver or passenger seat area.

As another alternative, the system may also include a low temperature cutout 90. When present, low temperature cutout 90 functions as a safety device that shuts off the system when the occupants are out of the vehicle for an extended period of time, thereby preventing freeze-up of the evaporator coil. In a situation in which the refrigeration system is running continuously but the evaporator fans are not, the evaporator coil continues to get colder, eventually getting cold enough to freeze. When frozen, air cannot be blown through the coil. The optional low temperature cutout is designed to shut off the system when the temperature of the evaporator coils reach a designated temperature, thereby preventing freeze-up from occurring.

The refrigeration system utilized for cooling the vehicle may utilize conventional components commonly used for such purposes. In one such test system, a Danfoss BF50f 24 volt compressor was utilized, along with four 90 cubic feet per minute (cfm) fans. Two of the fans were condenser fans, and two were evaporator fans. The metering device employed in the test system was a 48 inch length of SUPCO #2 capillary tubing.

The system described hereinbelow is representative of a general use refrigeration system, insofar as the generation of cooling air is concerned. However, the use of the system with utility vehicles such as those described herein, and the addition of specialized features, such as the pressure switches, add versatility not conventionally present in such systems. Upon activation of the pressure switches, the evaporator fans are energized. Cycling of the fans in this manner provides several advantages. One such advantage is that while the fans are off, the refrigeration system continues to run. As a result, the evaporator continues to get colder. Thus, when the driver or a passenger sits on a seat and activates the evaporator fan corresponding to that seat, the fan blows a blast of cold air through the designated conduit and onto the occupant. This cools the driver and/or the passenger much more rapidly than if the fans run continuously. This is illustrated in Table 1, below.

TABLE 1
Cooling capacity testing; evaporator
fans cycled at one minute intervals:

Ambient temp.

| | 73.5 | 86 | 104 | 110 |
|---|---|---|---|---|
| Fans on | 50.9 | 58.1 | 70.0 | 74.4 |
| Fans off | 57.5 | 69.9 | 79.7 | 83.2 |
| Fans left on continuously | 59.3 | 70.3 | 82.2 | 86.2 |

All temperatures in ° F.

In the test of Table 1, the various entries represent readings taken at four different ambient (outside) temperatures to which the unit was exposed. To obtain the “Fans on” and “Fans off” readings, the unit was initially run with the evaporator fans on for about two minutes. The fans were turned off for about one minute and then on for about one minute. The one minute on/off cycles were repeated about ten times. The output temperature, i.e., the discharge air temperature from conduit 72, was recorded each time when the fans were turned on and again when they were turned off. The temperature readings in the Table represent the average of the various readings. The readings for the “Fans left on continuously” were taken after the unit was run for about two minutes with all fans on. The discharge air is coldest when the fans are first turned on, since the evaporator is at its coldest. The evaporator slowly warms up as the warm air blows over it. As demonstrated, colder air is produced by cycling the fans than by having them run all the time.

Another advantage of the use of the cycled fans as described herein relates to the fact that when the fans are not running, the evaporator is flooded with boiling liquid refrigerant. A small portion of the liquid refrigerant goes into the suction line of the system, and advances to the compressor, thereby cooling the compressor. The compressor cools itself during the time that the evaporator fans are off, running up to 30 degrees F. cooler than if the evaporator fans run continuously. This is illustrated in Table 2, below.

TABLE 2
Compressor dome temperature test; evaporator
fans cycled at one minute intervals:

| | Ambient temperature | |
|---|---|---|
| | 84.4 | 110 |
| Dome temp. at beginning of “Off” cycle | 87 | 114.3 |
| Dome temp. at end of “Off” cycle | 79 | 114.2 |
| Dome temp. with fans running continuously | 112 | 136 |

All temperatures in ° F.

The dome temperature readings were obtained by attaching a temperature sensing device directly to the exterior of the compressor, and recording the temperatures. Typically, the hotter the compressor is running, the less efficient it will be, and a greater amount of wear will occur on the internal components of the compressor. Thus, it is preferred that the compressor be maintained at a relatively cooler temperature. If the compressor gets too hot, an internal safety device will normally automatically shut off the compressor to mitigate damage.

The refrigerant system tested above utilized R-414b refrigerant. This refrigerant is available from ICOR International, Inc., of Indianapolis, Indiana, as HOT SHOT®. It is expected that other refrigerants will also be acceptable. It was found that some refrigerants, such as R-134a, did not work as well at high ambient conditions. This is likely due to the low critical temperature of R-134a, which results in R-134a losing refrigeration capacity at higher temperatures. Although other refrigerants may be acceptable under certain ambient conditions, for best results in the widest variety of conditions it is preferred to utilize a refrigerant having a boiling point between about −30 and −10 degrees F., and a critical temperature above 200 degrees F. As stated, however, those skilled in the art will appreciate that other refrigerants may also be acceptable for a particular set of conditions.

Thus, it may be observed that the inventive system provides effective cooling without the necessity of providing ice, mist, or other artificial means. With the inventive system, once the system is activated, the cooling air is produced. The system is capable of discharging air as much as almost 40 degrees F. below ambient temperature. With prior art evaporative and misting type systems, 16 to 18 degrees below ambient is considered good. Furthermore, the inventive system removes humidity, rather than generating additional humidity.

The unit may run on 24 volt DC power supplied by the same batteries that operate the vehicle. A typical power supply for such vehicles comprises a combination of three 8-volt batteries or four 6-volt batteries. Most standard deep cycle batteries are rated at 200 amp hours. That is, you can pull 1 amp from the battery for 200 hours before the battery is depleted. Three batteries would total 600 amp hours, and four batteries would total 800 amp hours. The unit shown herein draws less than four amps with all of the fans on.

Over a five hour period of use, this would total only twenty amp hours of power, or about 3.3% of the total battery charge in the worst case of utilizing three 8 volt batteries. Thus, under conditions of normal usage of such vehicles, the power supply is more than ample for providing sufficient cooling throughout the period of use.

It is therefore intended that the foregoing detailed description be regarded as illustrative rather than limiting, and that it be understood that it is the following claims, including all equivalents, that are intended to define the spirit and scope of this invention.

1. A system for cooling an occupant of a vehicle, comprising:
a refrigeration unit carried by said vehicle, said refrigeration unit capable of generating a mechanically cooled fluid; and
at least one fan for directing said mechanically cooled fluid to a designated area

2. The cooling system of claim 1, further comprising a control switch for activating said fan independent of said refrigeration unit.

3. The cooling system of claim 2, wherein said control switch is operable to activate said fan responsive to pressure exerted on said switch.

4. The cooling system of claim 3, wherein said vehicle includes at least one passenger seat, and said switch is operable to activate said fan upon pressure exerted on said passenger seat.

5. The cooling system of claim 4, further comprising two fans, each of said fans oriented for directing mechanically cooled fluid to respective designated areas.

6. The cooling system of claim 5, further comprising two control switches, each switch operable for activating a separate one of said fans.

7. The cooling system of claim 6, wherein said vehicle includes two passenger seats, each of said control switches operable to activate a separate one of said fans upon pressure exerted on said passenger seat by a separate occupant of said vehicle.

8. The cooling system of claim 1, wherein said vehicle is at least partially powered by a storage battery.

9. The cooling system of claim 1, wherein said vehicle is at least partially electrically powered.

10. The cooling system of claim 1, wherein said vehicle is a golf cart.

11. The cooling system of claim 1, wherein said system additionally comprises a heating element, and a mechanism for selectively activating a separate one of the heating element and the refrigeration unit.

12. The cooling system of claim 5, further comprising two conduits, each said conduit oriented for receiving mechanically cooled fluid from a respective fan, and directing said mechanically cooled fluid to one of said respective designated areas.

13. The cooling system of claim 1, further comprising a cutout for preventing further generation of said mechanically cooled fluid upon occurrence of a designated condition.

14. A vehicle, comprising:
a refrigeration unit carried by said vehicle, said refrigeration unit capable of generating a mechanically cooled fluid for cooling a designated area;
at least one fan for directing said mechanically cooled fluid to said designated area; and
a power system for facilitating movement of said vehicle, said power system comprising a battery.

15. The vehicle of claim 14, further comprising a control switch for activating said fan independent of said refrigeration unit.

16. The vehicle of claim 15, wherein said control switch is operable to activate said fan responsive to pressure exerted on said switch.

17. The vehicle of claim 16, further comprising two fans, each of said fans oriented for directing mechanically cooled fluid to respective designated areas, and said vehicle comprises two control switches, each switch operable for activating a separate one of said fans.

18. The vehicle of claim 14, wherein said power system is also operable for generating said mechanically cooled fluid.

19. A cooling system for a utility vehicle, comprising:
a refrigeration unit carried by said vehicle, said refrigeration unit capable of generating a mechanically cooled fluid, said refrigeration unit comprising a condenser, a compressor and an evaporator;
a plurality of evaporator fans for directing said mechanically cooled fluid to respective designated areas; and
a plurality of control switches, each said switch operable to activate a separate one of said fans independent of operation of said refrigeration unit.

20. The cooling system of claim 19, wherein said cooling system comprises two evaporator fans and two control switches, each of said switches positioned with respect to a separate seating area of said vehicle such that a pressure exerted upon said switch by a passenger occupying said seating area activates said separate one of said fans.
